(19) United States
(12) Patent Application Publication
(10) Pub. No.: US 2014/0102277 A1
(43) Pub. Date: Apr. 17, 2014

(54) HEIGHT ADJUSTMENT DEVICE FOR BAND SAW MACHINE

(71) Applicant: KING SAW MACHINERY LTD., Taichung (TW)

(72) Inventor: Ching-Feng CHANG, Taichung (TW)

(73) Assignee: KING SAW MACHINERY LTD., Taichung (TW)

(21) Appl. No.: 13/649,481

(22) Filed: Oct. 11, 2012

(51) Int. Cl. B23D 55/02

(52) U.S. Cl. 83/788

(57) ABSTRACT

A height adjustment device for a band saw machine includes a fixing unit, an adjustment unit which is slidable relative to the fixing unit and at least one fixing member to secure the fixing unit the adjustment unit. Through the position of the adjustment unit relative to the fixing unit, the height of the band saw machine can be adjusted according to the user's height for the user to operate the band saw machine conveniently.

### BACKGROUND OF THE INVENTION

1. Field of the Invention

The present invention relates to a height adjustment device for a band saw machine.

2. Description of the Prior Art

A conventional band saw machine is used to cut a workpiece. In general, the band saw machine comprises a machine base and a worktable on the machine base. The worktable has a through hole. The machine base is provided with a drive source. The drive source is connected with a band saw.

The band saw is inserted through the through hole of the worktable. When in use, the user pushes the workpiece from one end to another end of the worktable. The workpiece is divided into two pieces by the band saw which is driven by the drive source.

However, the machine base of the band saw machine is immovable. The height of the band saw machine cannot be adjusted according to the user's height, so it is inconvenient for different users to operate the conventional band saw machine. For a short user, he/she has to stand on a stepping stone or the like to operate the band saw machine. This way is very dangerous. Besides, the conventional band saw machine is fixed. It is very inconvenient to move the band saw machine. Accordingly, the inventor of the present invention has devoted himself based on his many years of practical experiences to solve these problems.

### SUMMARY OF THE INVENTION

The primary object of the present invention is to provide a height adjustment device for a band saw machine. The height of the band saw machine can be adjusted according to the user's height for the user to operate the band saw machine conveniently.

In order to achieve the aforesaid object, the height adjustment device of the present invention is mounted to a band saw machine and comprises a fixing unit, an adjustment unit and at least one fixing member. The fixing unit is coupled to the band saw machine. The fixing unit has at least one first adjustment hole. The adjustment unit is secured to the fixing unit and corresponds in position to the first adjustment hole of the fixing unit. The adjustment unit is slidable relative to the fixing unit. The adjustment unit has at least one second adjustment hole. The fixing member is inserted in the first adjustment hole and the second adjustment hole to secure the fixing unit and the adjustment unit.

When the user wants to adjust the height of the band saw machine, the fixing member is pulled to disengage from the first adjustment hole and the second adjustment holes, such that the adjustment unit is slidable relative to the fixing unit. The adjustment unit is slidably moved relative to the fixing unit to adjust the height of the band saw machine. After that, the user aligns the first adjustment hole and the second adjustment hole again, and then the fixing member is inserted through the first adjustment holes and screwed to the second adjustment hole to connect the adjustment unit and the fixing unit. Through the height adjustment device of the present invention, the height of the band saw machine can be adjusted according to the user's height. It is convenient for the user to operate the band saw machine. The present invention also enhances the safety for the user to operate the band saw machine.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is a sectional view according to the first embodiment of the present invention;

FIG. 4 is a schematic view showing operation of the first embodiment of the present invention;

FIG. 5 is an exploded view showing the adjustment leg according to the first embodiment of the present invention;

FIG. 6 is a sectional view showing the adjustment leg according to the first embodiment of the present invention;

FIG. 7 is a schematic view showing operation of the adjustment leg according to the first embodiment of the present invention;

FIG. 8 is a sectional view according to a second embodiment of the present invention;

FIG. 9 is a schematic view showing operation of the second embodiment of the present invention;

FIG. 10 is a sectional view according to a third embodiment of the present invention;

FIG. 11 is a schematic view showing operation of the third embodiment of the present invention;

FIG. 12 is a perspective view according to a fourth embodiment of the present invention;

FIG. 13 is a sectional view according to the fourth embodiment of the present invention; and

FIG. 14 is a schematic view showing operation of the fourth embodiment of the present invention.

### DETAILED DESCRIPTION OF THE PREFERRED EMBODIMENTS

Embodiments of the present invention will now be described, by way of example only, with reference to the accompanying drawings.

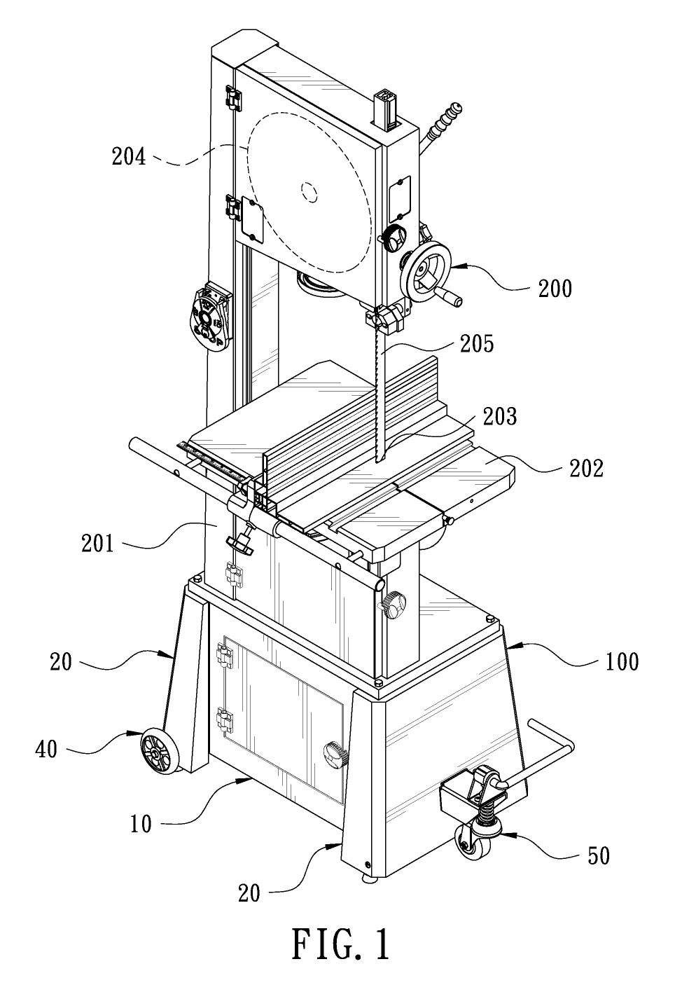

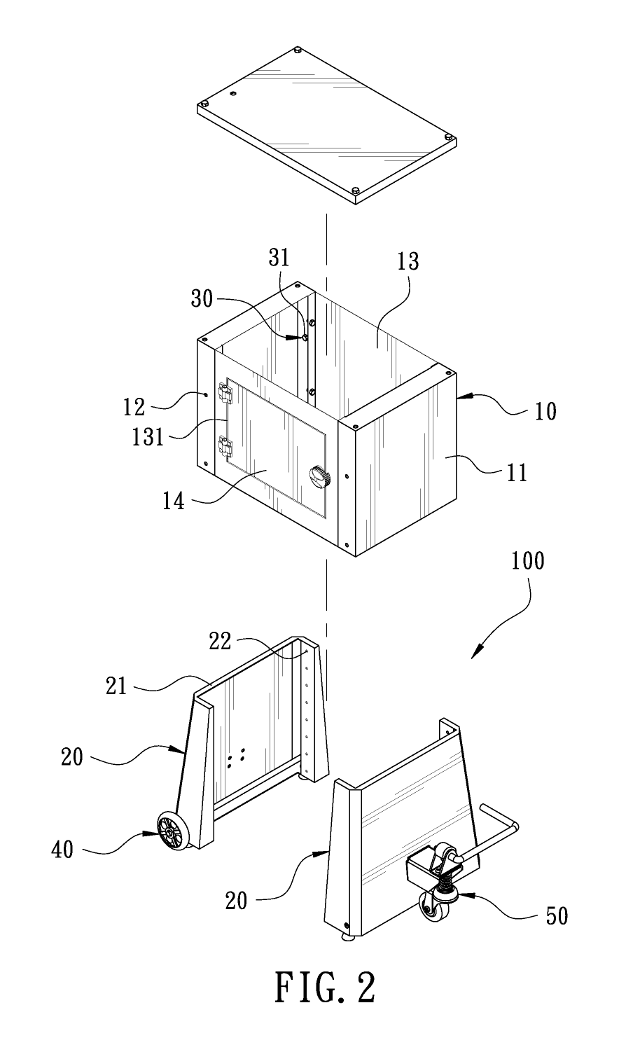

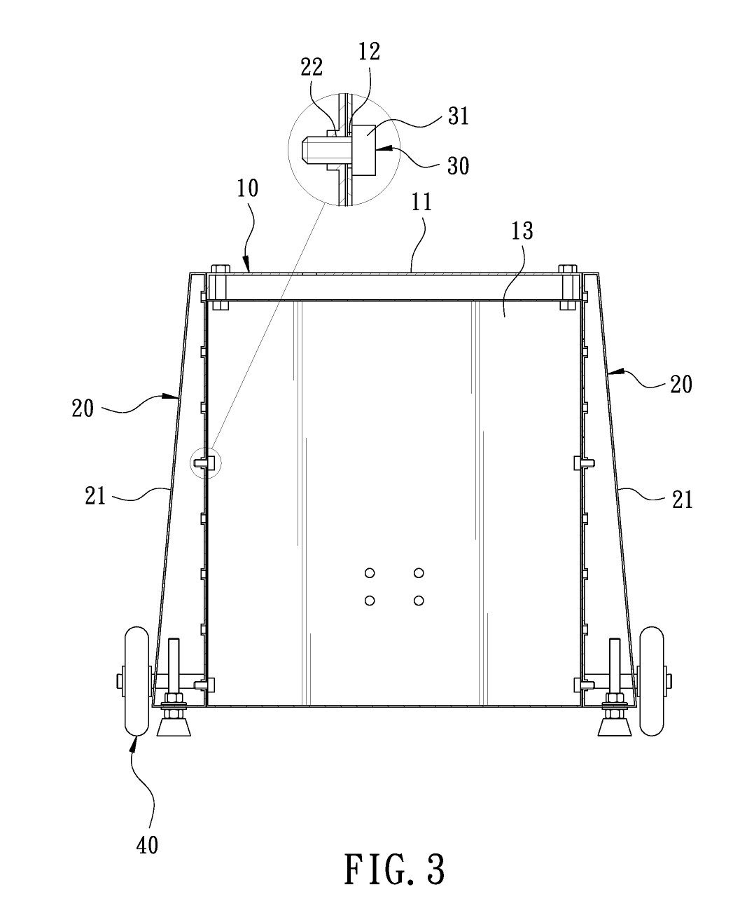

FIG. 1 is a perspective view according to a preferred embodiment of the present invention. FIG. 2 is an exploded view according to the preferred embodiment of the present invention. FIG. 3 is a sectional view according to the preferred embodiment of the present invention. The present invention discloses a height adjustment device 100 for a band saw machine. The height adjustment device 100 is coupled to a band saw machine 200. The band saw machine 200 comprises a machine base 201 and a worktable 202 on the machine base 201. The worktable 202 has a through hole 203. The machine base 201 is provided with a drive source 204. The drive source 204 is connected with a band saw 205. The band saw 205 is inserted through the through hole 203 of the worktable 202. The height adjustment device 100 comprises a fixing unit 10, an adjustment unit 20 and at least one fixing member 30.

The fixing unit 10 is coupled to the bottom of the machine base 201 of the band saw machine 200 and comprises a fixing base 11. The fixing unit 10 has at least one first adjustment hole 12. In this embodiment, the fixing base 11 of the fixing unit 10 has a plurality of spaced first adjustment holes 12 on a circumferential side thereof. The first adjustment holes 12 are arranged in a line and disposed at two opposing sides of the fixing base 10. The fixing base 11 of the fixing unit 10 has a chamber 13 therein and an opening 131 at one side thereof. The opening 131 communicates with the chamber 13. The fixing unit 10 further comprises a door 14 which is pivotally connected at the opening 131.

The adjustment unit 20 comprises at least one adjustment base 21. The adjustment unit 20 is secured to the fixing unit 10 and corresponds in position to the first adjustment hole 12. The adjustment unit 20 is slidable relative to the fixing unit 10. The adjustment unit 20 has at least one second adjustment hole 22. In this embodiment, the height adjustment device 100 comprises two adjustment bases 21 which are located at the two opposing sides of the fixing unit 10. Each adjustment base 21 has a plurality of spaced second adjustment holes 12 on a circumferential side thereof. The second adjustment holes 22 are arranged in a line corresponding to the first adjustment holes 12.

The fixing member 30 is inserted in the first adjustment hole 12 and the second adjustment hole 22 to secure the fixing unit 10 and the adjustment unit 20. In this embodiment, the height adjustment device 100 comprises a plurality of fixing members 30 corresponding in number to the first adjustment holes 12. The fixing member 30 is a bolt 31.

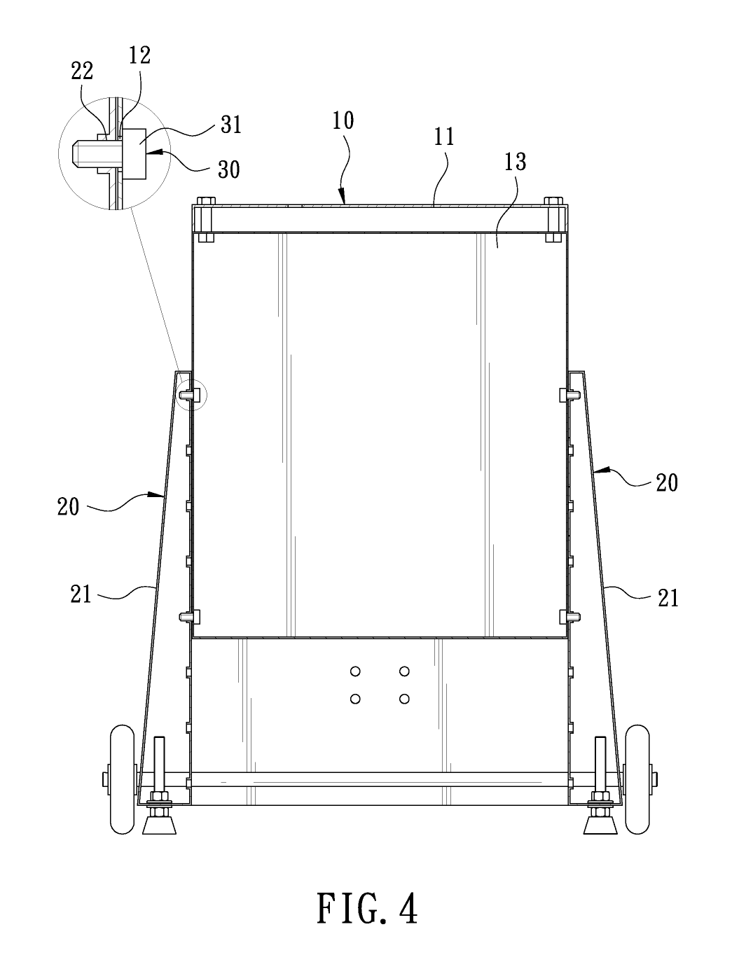

FIG. 4 is a schematic view showing operation of the first embodiment of the present invention. When the user wants to adjust the height of the band saw machine 200, he/she first opens the door 14 to expose the fixing members 30 and then the fixing members 30 are loosened to disengage the fixing members 30 from the first adjustment holes 12 and the second adjustment holes 22, such that the adjustment unit 20 is slidable relative to the fixing unit 10. The adjustment unit 20 is slidably moved relative to the fixing unit 10 to adjust the height of the band saw machine 200. After that, the user aligns the first adjustment holes 12 and the second adjustment holes 22, and then the fixing members 30 are inserted through the first adjustment holes 12 and screwed to the second adjustment holes 22 to connect the adjustment unit 20 and the fixing unit 10. In this way, the height adjustment of the band saw machine 200 is completed. Through the height adjustment device 100 of the present invention, the height of the band saw machine 200 can be adjusted according to the user's height. It is convenient for the user to operate the band saw machine 200. The present invention also enhances the safety for the user to operate the band saw machine 200.

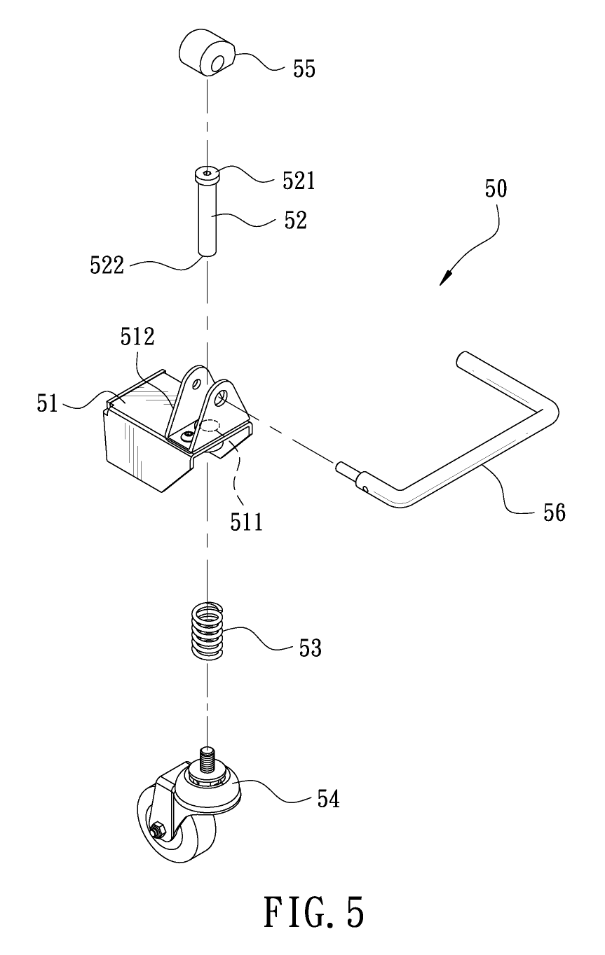

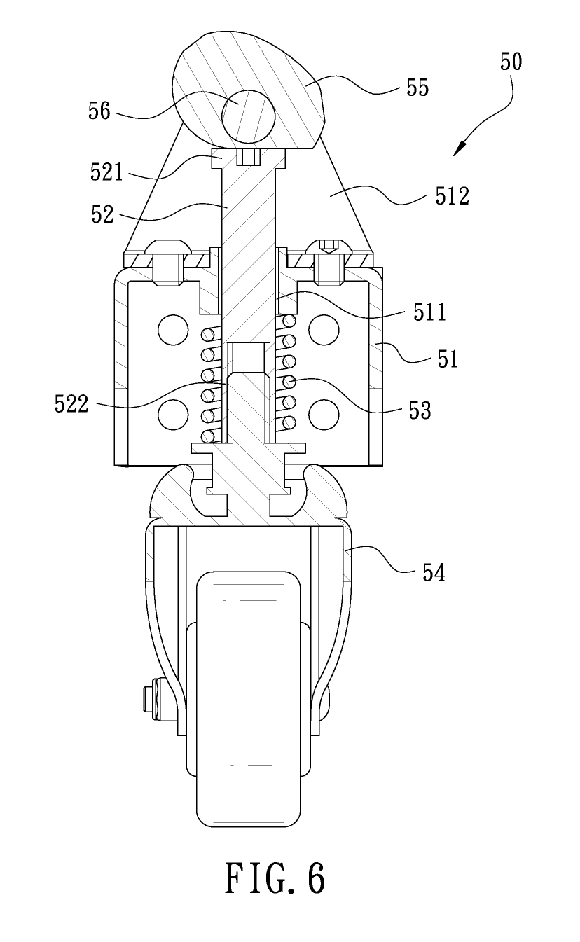

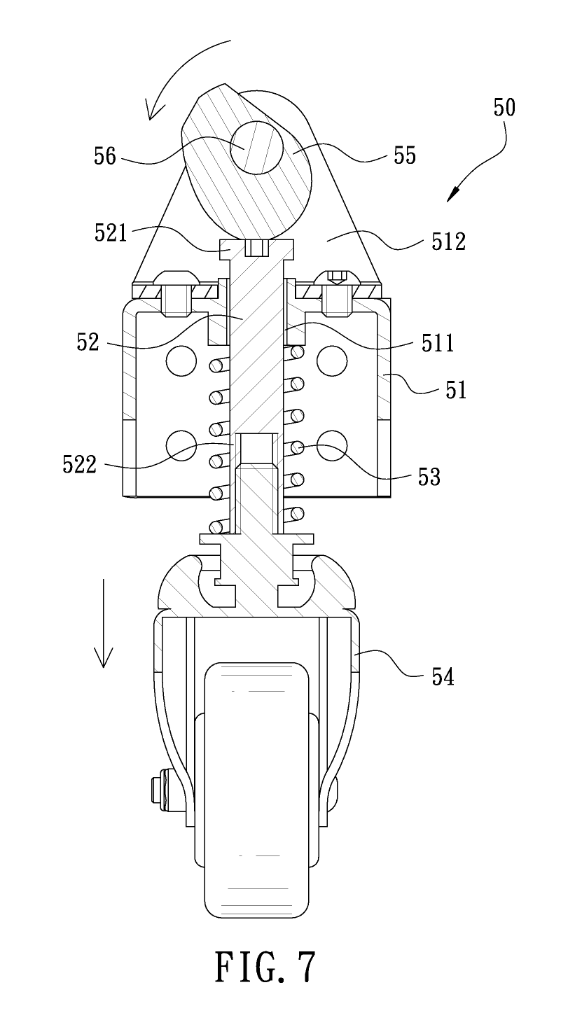

FIG. 5 is an exploded view showing the adjustment leg according to the first embodiment of the present invention. FIG. 6 is a sectional view showing the adjustment leg according to the first embodiment of the present invention. FIG. 7 is a schematic view showing operation of the adjustment leg according to the first embodiment of the present invention. The height adjustment device 100 further comprises a plurality of rollers 40 and an adjustment leg 50. The rollers 40 and the adjustment leg 50 are connected to the adjustment unit 10 to assist in moving the band saw machine 200. The adjustment leg 50 comprises a fixing frame 51, an adjustment axle 52, a spring 53, a wheel body 54, a cam 55, and an operation lever 56.

The fixing frame 51 is coupled to the adjustment unit 20. The fixing frame 51 has an axle hole 511 and a pair of pivot plates 512 close to the axle hole 511.

The adjustment axle 52 is inserted in the axle hole 511. One end of the adjustment axle 52 is exposed out of the axle hole 511 and formed with a head portion 521, and another end of the adjustment axle 52 is extended out of the axle hole 511 to form a connection end 522.

The spring 53 is fitted on the adjustment axle 52 and located between the fixing frame 51 and the connection end 522.

The wheel body 54 is pivotally connected to the connection end 522 of the adjustment axle 52.

The cam 55 is pivotally connected between the pair of pivot plates 512 and leans against the head portion 521 of the adjustment axle 52.

The operation lever 56 is connected to the cam 55.

As shown in FIG. 7, when the user wants to move the band saw machine 200, the operation lever 56 is pulled upward to turn the cam 55 to press the head portion 521 of the adjustment axle 52. The adjustment axle 52 is moved downward by the cam 55 to link the wheel body 54 to be on the ground so as to lift the height adjustment device 100, so that the band saw machine 200 can be moved through the wheel body 54 and the rollers 40. When the band saw machine 200 is moved to a desired position, the operation lever 56 is pressed down to restore the adjustment axle 52 and the wheel body 54 is away from the ground, so that the band saw machine 200 is secured on the ground steady. Thus, the height adjustment device 100 of the present invention can facilitate movement of the band saw machine 200 and the band saw machine 200 can be secured at another position.

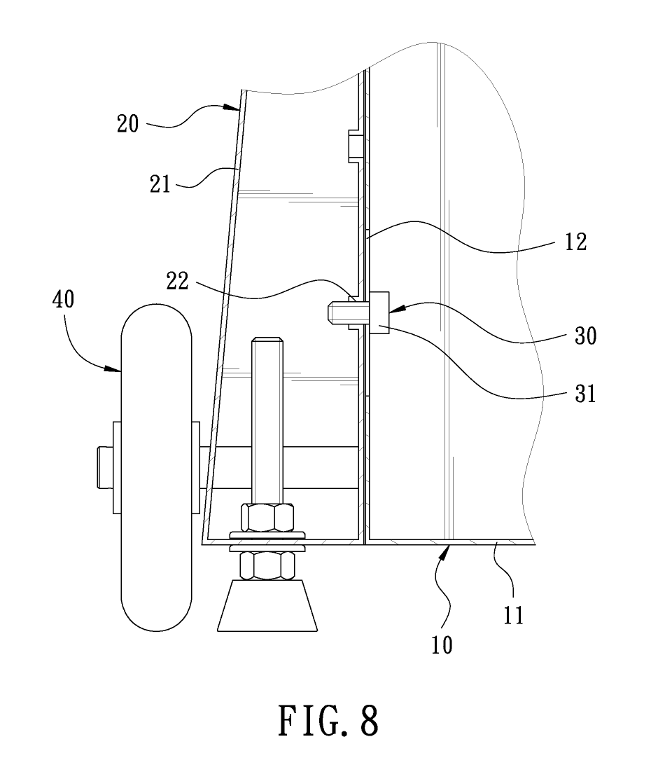

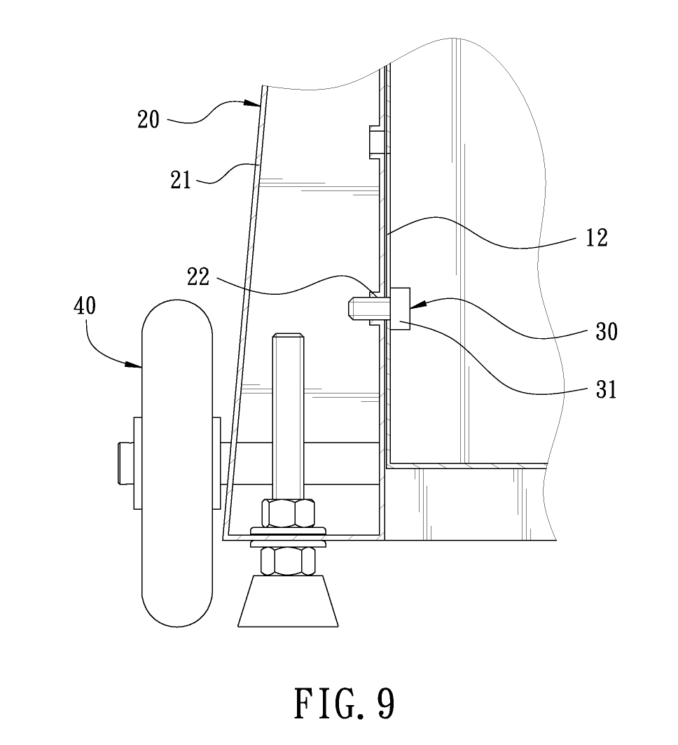

FIG. 8 is a sectional view according to a second embodiment of the present invention. FIG. 9 is a schematic view showing operation of the second embodiment of the present invention. The second embodiment of the height adjustment device 100 is substantially similar to the first embodiment with the exceptions described hereinafter. The first adjustment hole 12 is an elongated hole, and the second adjustment hole 22 is a threaded hole. The fixing member 30 is inserted through the first adjustment hole 12 and screwed to the second adjustment hole 22. When the user wants to adjust the height adjustment device 100, the fixing member 30 is slightly loosened for the adjustment unit 20 to slide relative to the fixing unit 10. After movement, the fixing member 30 is tightened again to secure the adjustment unit 20 and the fixing unit 10 to achieve a stepless adjustment effect.

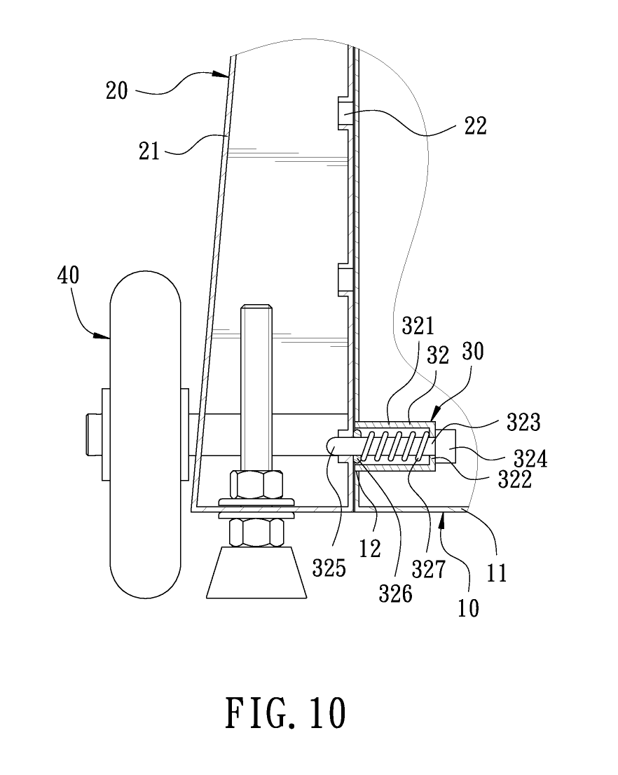

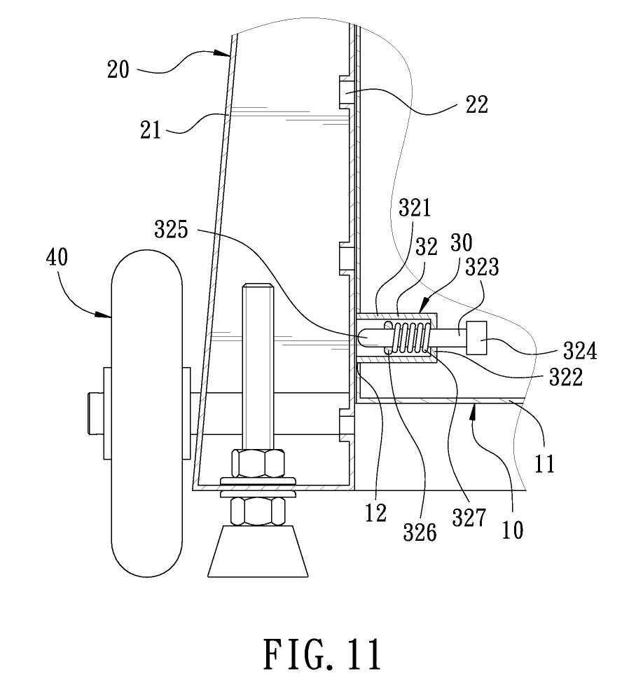

FIG. 10 is a sectional view according to a third embodiment of the present invention. FIG. 11 is a schematic view showing operation of the third embodiment of the present invention. The third embodiment of the height adjustment device 100 is substantially similar to the first embodiment with the exceptions described hereinafter. The fixing member 30 is an elastic pin 32 having a fixing sleeve 321. One end of the fixing sleeve 321 is secured to the first adjustment hole 12, and another end of the fixing sleeve 321 is reduced inward to form a flange 322. A pin 323 is provided in the fixing sleeve 321. One end of the pin 323 is extended out of the fixing sleeve 321 and enlarged to form a head 324, and another end of the pin 323 is an engaging end 325 which is inserted in the second adjustment hole 22. The pin 323 has a protrusion 326 on an outer wall thereof. The protrusion 326 is located in the fixing sleeve 321. A spring 327 is fitted on the pin 323. The spring 327 is located between the protrusion 326 and the flange 322. When the user wants to adjust the height adjustment device 100, the pin 323 is pulled outward for the engaging end 325 to disengage from the second adjustment hole 22 so that the adjustment unit 20 can slide relative to the fixing unit 10. After movement, the user releases the pin 323. The pin 323 is biased by the spring 327 to move toward the second adjustment hole 22 for the engaging end 325 to be inserted in another adjustment hole 22 to secure the adjustment unit 20 and the fixing unit 10 to complete the adjustment.

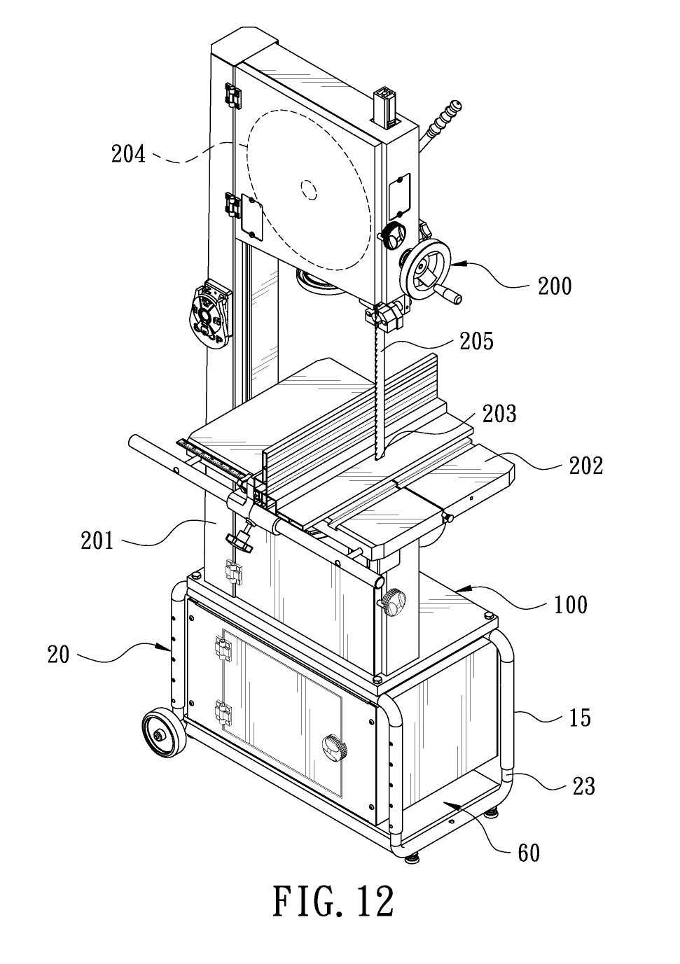

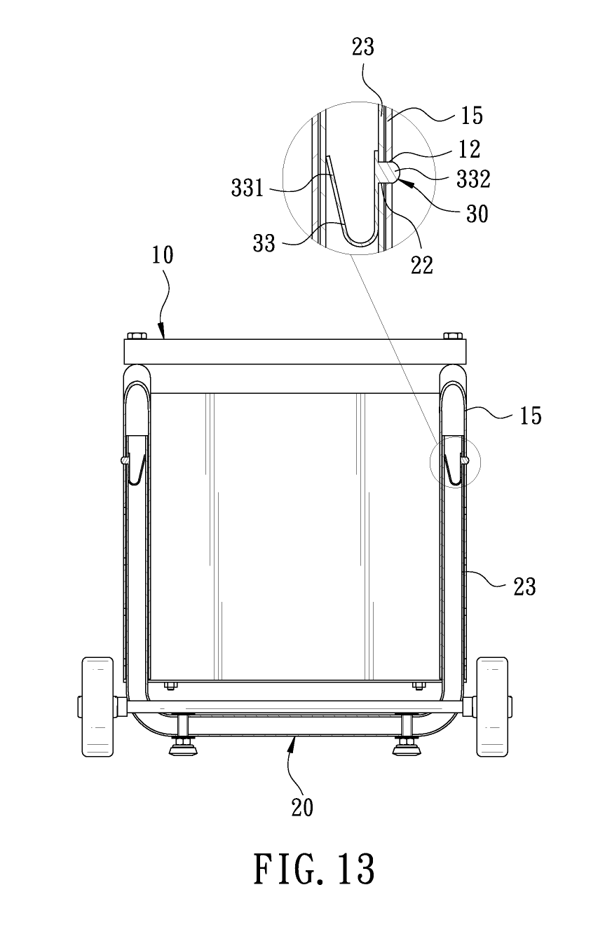

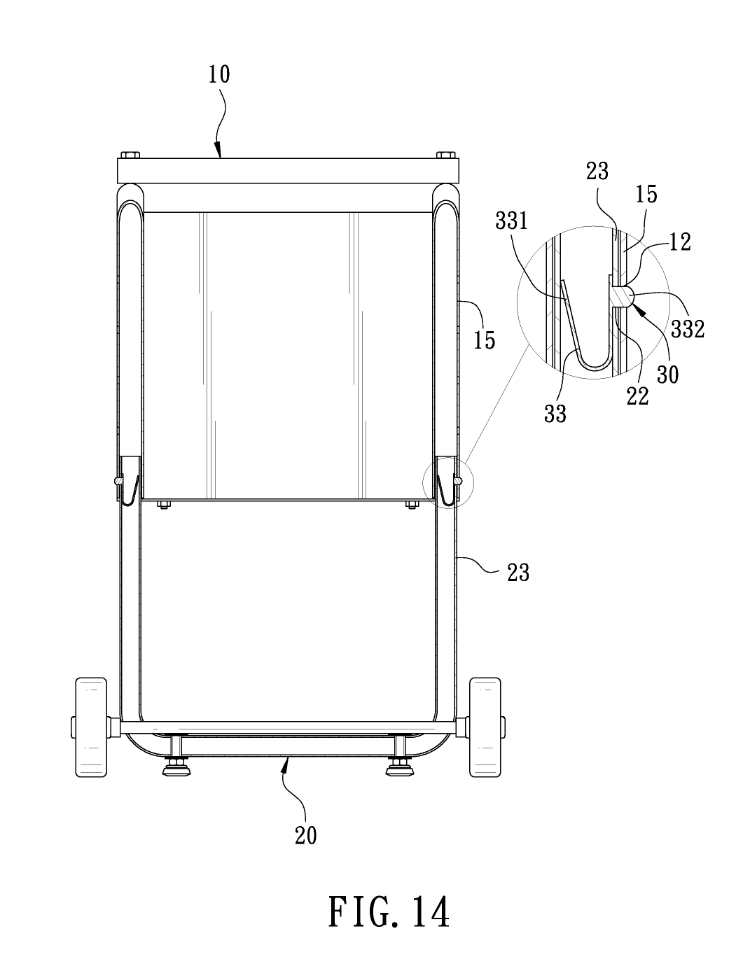

FIG. 12 is a perspective view according to a fourth embodiment of the present invention. FIG. 13 is a sectional view according to the fourth embodiment of the present invention. FIG. 14 is a schematic view showing operation of the fourth embodiment of the present invention. The fourth embodiment of the height adjustment device 100 is substantially similar to the first embodiment with the exceptions described hereinafter. The fixing unit 10 has a plurality of first adjustment pipes 15. Each first adjustment pipe 15 has a plurality of spaced first adjustment holes 12 on a circumferential side thereof in an axial direction. The adjustment unit 20 has a plurality of second adjustment pipes 23 corresponding to the first adjustment pipes 15. The second adjustment pipes 23 are respectively inserted in the first adjustment pipes 15. Each second adjustment pipe 23 has at least one second adjustment hole 22 on a circumferential side thereof. The fixing member 30 is a U-shaped elastic plate 33 inserted in second adjustment pipe 22. One end of the U-shaped elastic plate 33 is a fixed end 331 secured to the inner wall of the second adjustment pipe 22, and another end of the U-shaped elastic plate 33 is provided with a protruding post 332. The protruding post 332 is inserted in the second adjustment hole 22 and the first adjustment hole 21. Furthermore, the height adjustment device 100 further comprises a pallet 60 mounted to the adjustment unit 20 for articles to be placed thereon. As shown in FIG. 14, when the user wants to adjust the height adjustment device 100, the protruding post 332 is pressed to disengage from the first adjustment hole 12 so that the first adjustment pipe 15 is slideable relative to the second adjustment pipe 23. The adjustment unit 20 is moved relative to the fixing unit 10 to adjust the height of the band saw machine 200. After movement, when the second adjustment hole 22 is aligned with another first adjustment hole 12, the protruding post 332 biased by the U-shaped elastic plate 33 will be inserted in the first adjustment hole 12 to secure the adjustment unit 20 and the fixing unit 10 to complete the height adjustment of the band saw machine 200. This embodiment has the same effect as the first embodiment to operate the band saw machine 200 conveniently.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A height adjustment device mounted to a band saw machine, comprising:
a fixing unit coupled to the band saw machine, the fixing unit having at least one first adjustment hole;
an adjustment unit secured to the fixing unit and corresponding in position to the first adjustment hole, the adjustment unit being slidable relative to the fixing unit, the adjustment unit having at least one second adjustment hole; and
at least one fixing member, the fixing member being inserted in the first adjustment hole and the second adjustment hole to secure the fixing unit and the adjustment unit.

2. The height adjustment device as claimed in claim 1, wherein the fixing unit comprises a fixing base, the fixing base having a plurality of spaced first adjustment holes on a circumferential side thereof, the adjustment unit comprising at least one adjustment base, each adjustment base having a plurality of spaced second adjustment holes on a circumferential side thereof.

3. The height adjustment device as claimed in claim 2, wherein the fixing base of the fixing unit has a chamber therein and an opening at one side thereof, the opening communicating with the chamber.

4. The height adjustment device as claimed in claim 3, wherein the fixing unit further comprises a door which is pivotally connected at the opening.

5. The height adjustment device as claimed in claim 1, wherein the first adjustment hole is an elongated hole and the second adjustment hole is a threaded hole.

6. The height adjustment device as claimed in claim 1, wherein the fixing unit has a plurality of first adjustment pipes, each first adjustment pipe having a plurality of spaced first adjustment holes on a circumferential side thereof in an axial direction, the adjustment unit having a plurality of second adjustment pipes corresponding to the first adjustment pipes, the second adjustment pipes being respectively inserted in the first adjustment pipes, each second adjustment pipe having at least one second adjustment hole on a circumferential side thereof.

7. The height adjustment device as claimed in claim 1, wherein the fixing member is a bolt.

8. The height adjustment device as claimed in claim 1, wherein the fixing member is an elastic pin having a fixing sleeve, one end of the fixing sleeve being secured to the first adjustment hole, another end of the fixing sleeve being reduced inward to form a flange, a pin being provided in the fixing sleeve, one end of the pin extending out of the fixing sleeve and being enlarged to form a head, another end of the pin being an engaging end, the engaging end being inserted in the second adjustment hole, the pin having a protrusion on an outer wall thereof, the protrusion being located in the fixing sleeve, a spring being fitted on the pin, the spring being located between the protrusion and the flange.

9. The height adjustment device as claimed in claim 6, wherein the fixing member is a U-shaped elastic plate inserted in second adjustment pipe, one end of the U-shaped elastic plate being a fixed end secured to an inner wall of the second adjustment pipe, another end of the U-shaped elastic plate being provided with a protruding post, the protruding post being inserted in the second adjustment hole and the first adjustment hole.

10. The height adjustment device as claimed in claim 1, further comprising an adjustment leg, the adjustment leg comprising a fixing frame, an adjustment axle, a spring, a wheel body, a cam and an operation lever, the fixing frame being coupled to the adjustment unit, the fixing frame having an axle hole and a pair of pivot plates close to the axle hole, the adjustment axle being inserted in the axle hole, one end of the adjustment axle being exposed out of the axle hole and formed with a head portion, another end of the adjustment axle extending out of the axle hole to form a connection end, the spring being fitted on the adjustment axle and located between the fixing frame and the connection end, the wheel body being pivotally connected to the connection end of the adjustment axle, the cam being pivotally connected between the pair of pivot plates and leaning against the head portion of the adjustment axle, the operation lever being connected to the cam.

11. The height adjustment device as claimed in claim 1, further comprising a pallet mounted to the adjustment unit.
